(19) United States
(12) Patent Application Publication
(10) Pub. No.: US 2024/0351691 A1
(43) Pub. Date: Oct. 24, 2024

(54) SEATING SYSTEMS FOR INTERNAL CABINS OF AIRCRAFT

(71) Applicant: THE BOEING COMPANY, Arlington, VA (US)

(72) Inventors: Rohan Srinivas Sharma, Mountlake Terrace, WA (US); Paul Addis, Bothell, WA (US); Justin Tabora, Bothell, WA (US); Artur Hanski, Kirkland, WA (US)

(73) Assignee: THE BOEING COMPANY, Arlington, VA (US)

(21) Appl. No.: 18/415,792

(22) Filed: Jan. 18, 2024

Related U.S. Application Data
(60) Provisional application No. 63/496,972, filed on Apr. 19, 2023.

(51) Int. Cl. B64D 11/06

(52) U.S. Cl. CPC B64D 11/0693

(57) ABSTRACT

An aircraft includes an internal cabin having a tapered area. A first seating system including three seats coupled together is within a row within the tapered area. The three seats include an inboard seat, a middle seat, and an outboard seat.

### CROSS-REFERENCE TO RELATED APPLICATIONS

This application is a non-provisional conversion of, and claims priority to, U.S. Provisional Patent Application No. 63/496,972, filed Apr. 19, 2023, which is incorporated by reference in its entirety.

### FIELD OF THE DISCLOSURE

Examples of the present disclosure generally relate to seating systems for internal cabins of vehicles, and more particularly to systems and methods for providing seats within previously unused spaces of internal cabins of commercial aircraft.

### BACKGROUND OF THE DISCLOSURE

Vehicles such as commercial aircraft are used to transport passengers between various locations. A typical aircraft includes an internal cabin having seats for passengers.

Internal cabins of certain commercial aircraft, such as a Boeing 787, have areas where seating configurations are limited. For example, in certain areas, a seating configuration is limited to two outboard double seats in front of a monument (such as a lavatory), an egress path to a door, and/or the like.

FIG. 1 illustrates a top plan view of the aforementioned area of an internal cabin. As shown in FIG. 1, a tapered portion 10 of the internal cabin forms an unused space 12 within the internal cabin. Double seats 14 (that is, two seats coupled together) are disposed adjacent to the unused space 12. As shown in FIG. 1, a width W1 of a double seat is 40.45. The width W1 includes a width of each seat (in particular, 17.6 inches), and width of 1.75 inches for each of three armrests.

The tapered portion 10 typically precludes triple seats (that is, three seats coupled together) proximate to the tapered portion 10. A triple seat 16 is shown in a row in front of the double seats 14. The triple seat 16 in front of the double seats 14 has a width W2, such as 57.7 inches. The width W2 includes a width of one seat at 17.6 inches, and widths of each of two other seats of 16.5 inches, and a width of 1.75 inches for each of four armrests. In contrast, triple seats within a middle section of the internal cabin inboard from the triple seat 16 can have a width W3 of 59.8 inches (with each of the three seats having a width of 17.6 inches).

In general, the taper of the cross section and position of frames proximate to the tapered portion 10 typically preclude triple seats, thereby causing the unused space 12.

### SUMMARY OF THE DISCLOSURE

A need exists for a seating system that is able to be disposed within an unused space of an internal cabin of an aircraft. A need exists for additional seats within an internal cabin of an aircraft.

With those needs in mind, examples of the present disclosure provide an aircraft including an internal cabin having a tapered area. A first seating system including three seats coupled together is within a row within the tapered area. The three seats include an inboard seat, a middle seat, and an outboard seat.

In at least one example, the tapered area is proximate to an aft end of the aircraft. For example, the tapered area includes a last row of a passenger seating area.

In at least one example, a second seating system is in front of the first seating system. The first seating system extends a distance further into an aisle than the second seating system. In at least one example, the distance is between 0.1-2 inches.

In at least one example, the first seating system has a first width that differs from a second width of the second seating system. In at least one example, a third seating system is inboard from the first seating system. The third seating system has a third width that differs from each of the first width and the second width.

As an example, the first seating system has a width of 56.6 inches. As another example, the first seating system has a width of 55.6 inches. As another example, the first seating system has a width of 57.5 inches.

Certain examples of the present disclosure provide a method of utilizing previously unused spaced within an internal cabin of an aircraft. The method includes disposing a first seating system including three seats coupled together within a row within a tapered area of the internal cabin.

### BRIEF DESCRIPTION OF THE DRAWINGS

FIG. 1 illustrates a top plan view of a portion of an internal cabin of an aircraft.

FIG. 2 illustrates a perspective front view of an aircraft, according to an example of the present disclosure.

FIG. 3 illustrates a perspective interior view of an internal cabin of an aircraft, according to an example of the present disclosure.

FIG. 4 illustrates a top plan view of a portion of an internal cabin of an aircraft, according to an example of the present disclosure.

FIG. 5 illustrates a top plan view of a portion of an internal cabin of an aircraft, according to an example of the present disclosure.

FIG. 6 illustrates a top plan view of a portion of an internal cabin of an aircraft, according to an example of the present disclosure.

FIG. 7 illustrates a top plan view of a portion of an internal cabin of an aircraft, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

Examples of the present disclosure provide seating systems having three seats. The seating systems optimize centerline seats and outboard seats forward of a monument (such as a lavatory), an egress path to a door within an internal cabin of an aircraft, and/or the like. The seating systems provide enabling triple seat options that effectively replace a double seat that was typically disposed within previously unused space of the internal cabin. The seating systems shown and described herein reduce wasted space in front of an egress path to a door within an internal cabin of an aircraft (such as door 4 within a Boeing 787). The seating systems are configured to provide three passenger seats on both sides of an aisle, thereby adding two additional seats within an aisle that includes the previously unused space. The additional seats provided by the seating systems described herein provide increased revenue opportunities for airlines.

As described herein, an aircraft or other vehicle includes an internal cabin having a tapered area. A seating system is disposed within the tapered area. The searing system includes three seats within a row within the tapered area.

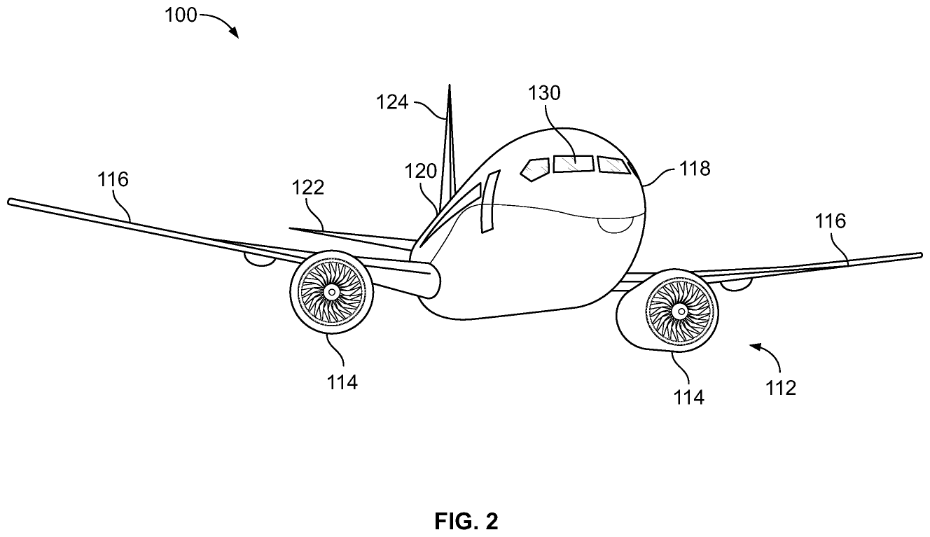

FIG. 2 illustrates a perspective front view of an aircraft 100, according to an example of the present disclosure. The aircraft 100 includes a propulsion system 112 that includes engines 114, for example. Optionally, the propulsion system 112 may include more engines 114 than shown. The engines 114 are carried by wings 116 of the aircraft 100. In other examples, the engines 114 may be carried by a fuselage 118 and/or an empennage 120. The empennage 120 may also support horizontal stabilizers 122 and a vertical stabilizer 124.

The fuselage 118 of the aircraft 100 defines an internal cabin 130, which includes a flight deck or cockpit, one or more work sections (for example, galleys, personnel carry-on baggage areas, and the like), one or more passenger sections (for example, first class, business class, and coach sections), one or more lavatories, and/or the like.

Alternatively, instead of an aircraft, examples of the present disclosure may be used with various other vehicles, such as automobiles, buses, locomotives and train cars, watercraft, and the like.

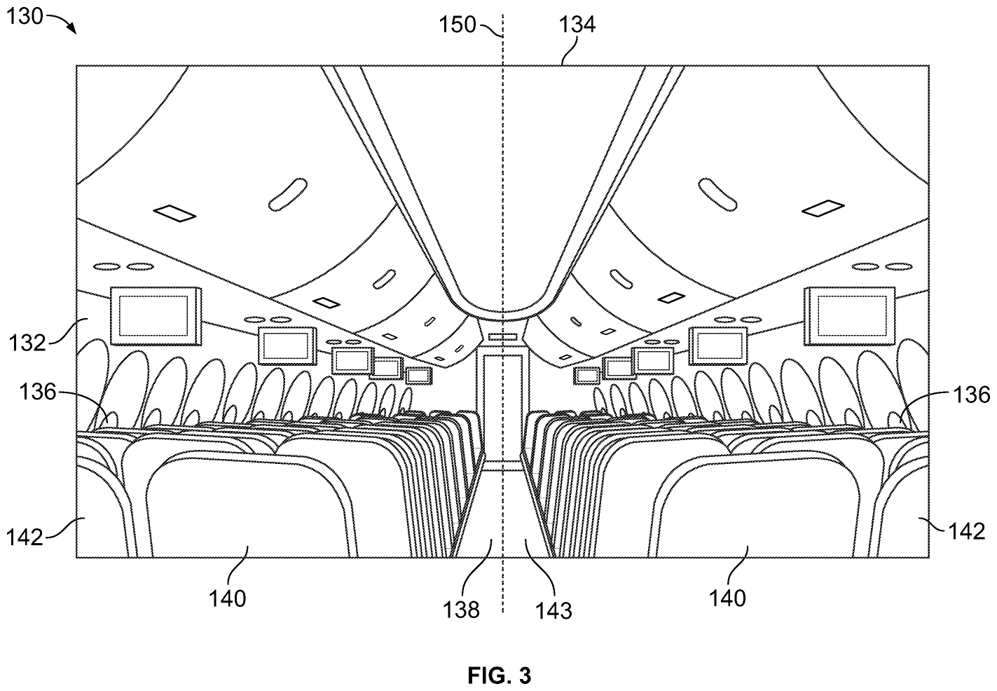

FIG. 3 illustrates a perspective interior view of an internal cabin 130 of an aircraft, according to an example of the present disclosure. The internal cabin 130 includes outboard walls 132 and a ceiling 134. Windows 136 may be formed within the outboard walls 132. A floor 138 supports rows of seats 140. As shown in FIG. 3, a row 142 may include three seats 140 on either side of an aisle 143. However, the row 142 may include more or less seats 140 than shown. Additionally, the internal cabin 130 may include more aisles than shown.

As used herein, the term “outboard” means a position that is further away from a central longitudinal plane 150 of the internal cabin 130 as compared to another component. The term “inboard” means a position that is closer to the central longitudinal plane 150 of the internal cabin 130 as compared to another component.

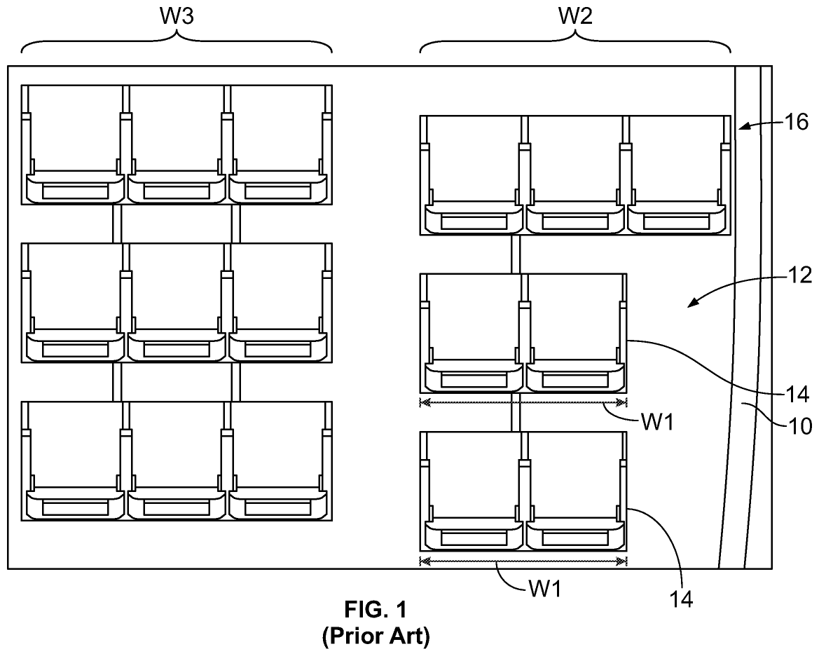

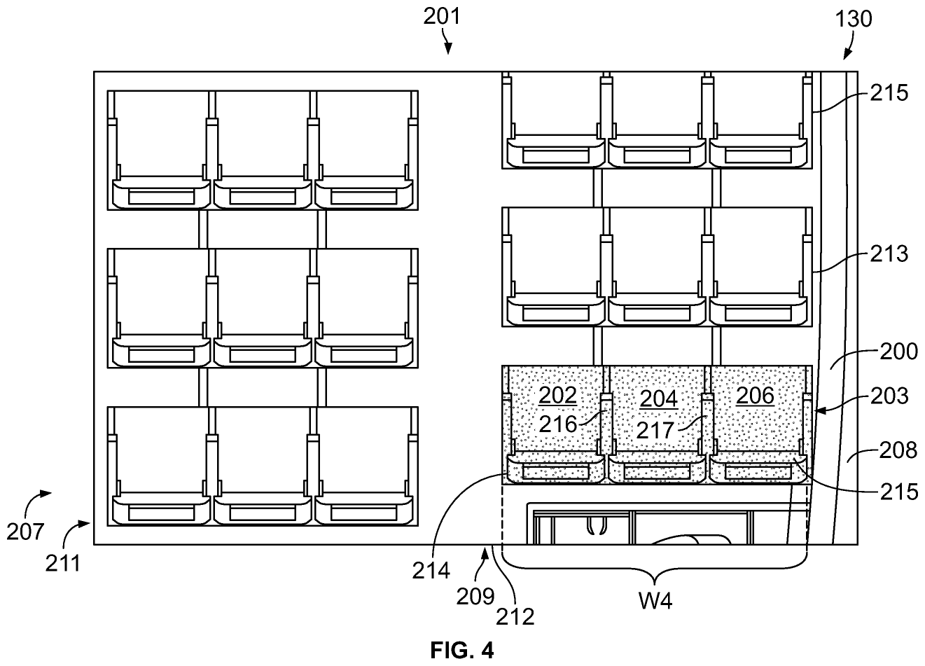

FIG. 4 illustrates a top plan view of a portion of an internal cabin 130 of an aircraft, according to an example of the present disclosure. A seating system 200 (for example, a first seating system) includes three seats 202 (inboard seat), 204 (middle seat), and 206 (outboard seat). The three seats 202, 204, and 206 are disposed within a common row 203. In particular, the three seats 202, 204, and 206 are coupled together to provide an integral seating assembly, and are disposed within the row 203 within the previously unused space 12. The seating system 200 having the three seats is located in the row 203 within a tapered area 208 that would have previously included unused space, such as the unused space 12 shown in FIG. 1. The tapered area 208 is an area within the internal cabin that is less wide than a majority of the passenger seating area 201. In at least one example, the tapered area 208 is proximate to an aft end of the aircraft. As an example, a last row 207 of the passenger seating area 201 can be in the tapered area 208.

The seating system 200 is slightly shifted (“joggled”) inboard into the aisle, such as by 1.1 inches, so that the seating system 200 can be disposed within the noted location of the tapered area 208. In at least one example, a width W4 of the seating system 200 is 56.6 inches. In particular, the width of the inboard seat 202 is 16.55 inches, the width of the middle seat 204 is 16.55 inches, and the width of the outboard seat 206 is 18 inches. Widths of outer armrests (that is, the armrests at opposite ends) 214 and 215 are each 1.5 inches, while widths of the two inner armrests (that is, the armrests between the ends) 216 and 217 are each 1.25 inches. Accordingly, the width W4 is 56.6 inches (16.55 inches+16.55 inches+18 inches+1.5 inches+1.25 inches+1.25 inches+1.5 inches). In contrast, the width of a seating system 211 (that is, a second seating system) that is inboard from the seating system 200 is W3, as shown and described with respect to FIG. 1. Further, the width of a seating system 213 (for example, a third seating system) in front of the seating system 200 is W2, as shown and described with respect to FIG. 1. The width of the seating system 215 in front of the seating system 213 can be W3.

In at least one example, the inboard seat 202 (that is, the seat 202 closest to the aisle 209 between the seating system 200 and the seating system 211 within the middle section of the passenger seating area 201) can extend into the aisle 209 a distance 212, which can be 1.1 inches. For example, an inboard armrest 214 of the inboard seat 202 extends into the aisle 209 the distance 212. In contrast, the seating system 213 immediately in front of the seating system 200 does not extend into the aisle 209 the distance 212.

As shown, the seating system 200 extends the distance 212 further into the aisle 209 as compared to the seating system 213, which is in front of the seating system 200. As noted, the distance 212 can be 1.1 inches. Optionally, the distance 212 can be less than 1.1 inches (such as 0.1-0.5 inches) or more than 1.1 inches (such as 1.2-2.5 inches).

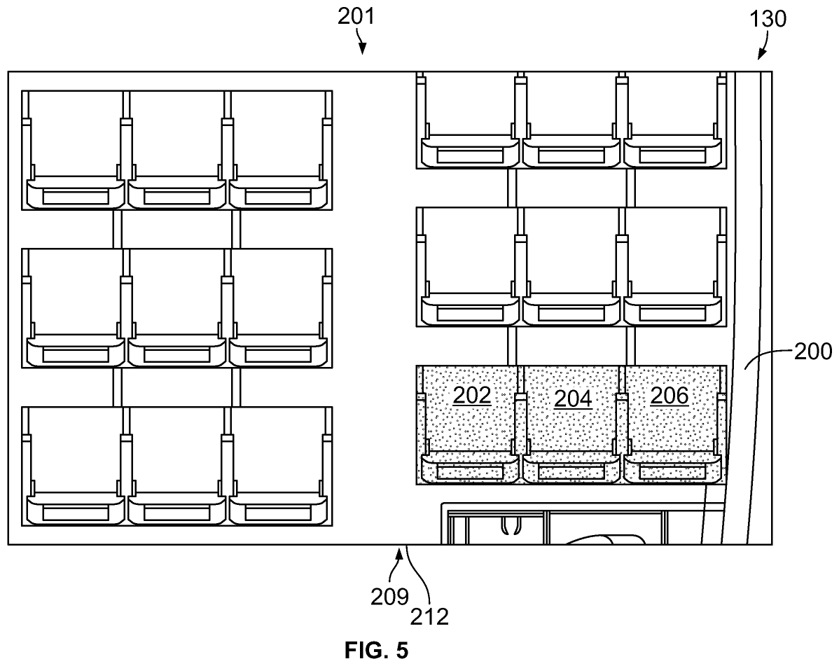

FIG. 5 illustrates a top plan view of a portion of an internal cabin 130 of an aircraft, according to an example of the present disclosure. In this example, the seating system 200 is shifted inboard into the aisle, such as by 0.1 inches, and the width of the seating system can be 55.6 inches. In this example, the distance 212 is 0.1 inches, thereby reducing the width W4 to 55.6 inches. In this example, the width of the outboard seat 206 can be 17 inches (instead of 18 inches), thereby decreasing the distance 212 into the aisle 209 by 1 inch.

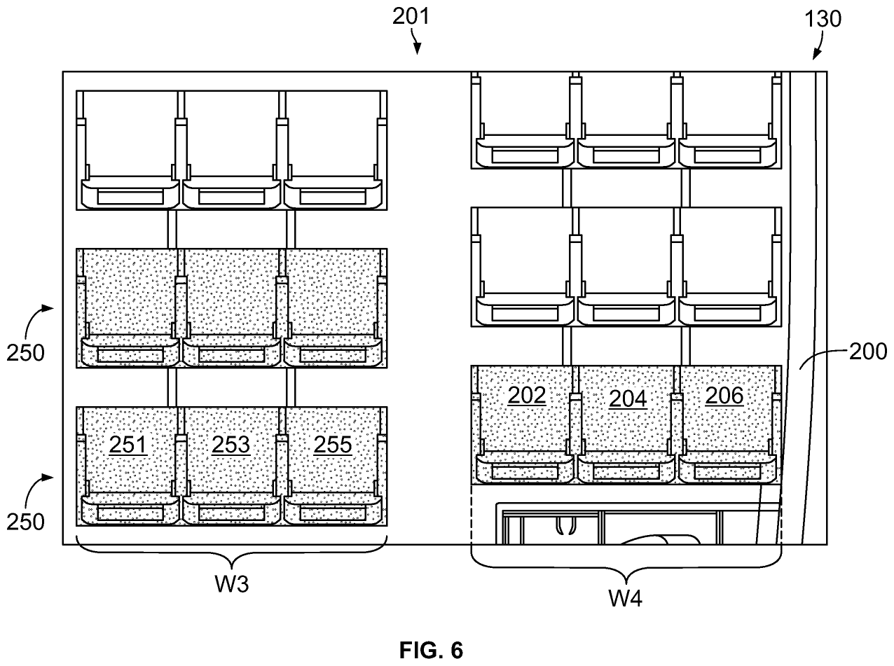

FIG. 6 illustrates a top plan view of a portion of an internal cabin 130 of an aircraft, according to an example of the present disclosure. In this example, the seating system 200 is shifted inboard into the aisle 209, such as by 2.0 inches, while one or more middle seat systems 250 can be shifted away from the aisle 209, such as by 1.4 inches. In this example, the width W4 can be 57.5 inches, with each of the inboard seat 202 and the middle seat 204 having a width of 17 inches, and the outboard seat having a width of 18 inches. The width W3 of each of the middle seat systems 250, which is shifted away from the aisle 209, is 57 inches (with a width of each of the seats 251, 253, and 255 being 17 inches, and the widths of the four armrests being 1.5 inches).

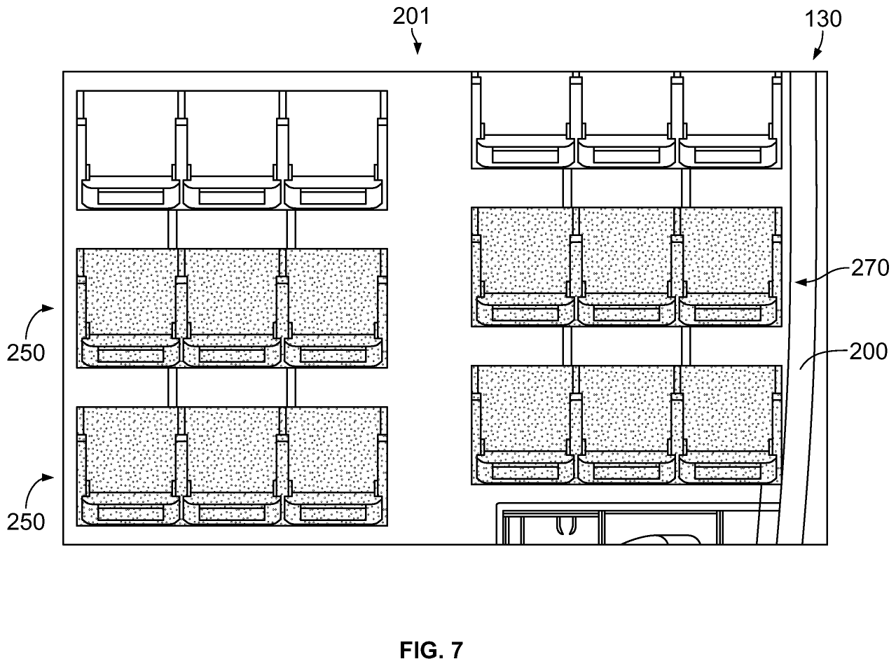

FIG. 7 illustrates a top plan view of a portion of an internal cabin 130 of an aircraft, according to an example of the present disclosure. In this example, a seating system 270 in a row in front of the seating system 200 can be shifted inboard into the aisle, such as by 1.0″ to provide a wider seating system 270, as compared to that shown in FIG. 6.

Referring to FIGS. 2-7, as described herein, examples of the present disclosure provide systems and methods of disposing seating systems within previously unused space of internal cabins. The seating systems and other seating systems within the internal cabin can be shifted in relation to aisles (such as between 0.1-2.5 inches), which can reduce a width of an aisle, but ensure comfortable seating spaces.

Space within a commercial aircraft is limited. Thus, seemingly small changes in seating systems (such as in relation to widths and shifts into aisles of less than 5 inches) can lead to dramatic changes in the ability to add seats within the internal cabin. Each seat added leads to additional revenue opportunities for an airline.

Certain examples of the present disclosure provide a method of utilizing previously unused space (such as the space 12 shown in FIG. 1) within an internal cabin 130 of an aircraft 100. The method includes disposing a first seating system 200 including three seats 202, 204, and 206 coupled together within a row 203 within a tapered area 208 of the internal cabin 130. The three seats include the inboard seat 202, the middle seat 204, and the outboard seat 206. In at least one example, the method also includes disposing a second seating system 213 in front of the first seating system 200. In at least one example, the first seating system extends a distance 212 further into an aisle 209 than the second seating system 213. In at least one example, the method also includes disposing a third seating system 211 inboard from the first seating system 200.

It is to be understood that numerical labels for certain features, such as in relation to seating system, widths, and the like are merely exemplary. That is, a first width, can be a second, third, or fourth width, or vice versa.

Further, the disclosure comprises examples according to the following clauses:

Clause 1. An aircraft comprising:
an internal cabin having a tapered area; and
a first seating system including three seats coupled together within a row within the tapered area,
wherein the three seats include an inboard seat, a middle seat, and an outboard seat.

Clause 2. The aircraft of Clause 1, wherein the tapered area is proximate to an aft end of the aircraft.

Clause 3. The aircraft of Clauses 1 or 2, wherein the tapered area includes a last row of a passenger seating area.

Clause 4. The aircraft of any of Clauses 1-3, further comprising a second seating system in front of the first seating system, wherein the first seating system extends a distance further into an aisle than the second seating system.

Clause 5. The aircraft of Clause 4, wherein the distance is between 0.1-2 inches.

Clause 6. The aircraft of Clauses 4 or 5, wherein the first seating system has a first width that differs from a second width of the second seating system.

Clause 7. The aircraft of any of Clauses 4-6, further comprising a third seating system inboard from the first seating system, wherein the third seating system has a third width that differs from each of the first width and the second width.

Clause 8. The aircraft of any of Clauses 1-7, wherein the first seating system has a width of 56.6 inches.

Clause 9. The aircraft of any of Clauses 1-7, wherein the first seating system has a width of 55.6 inches.

Clause 10. The aircraft of any of Clauses 1-7, wherein the first seating system has a width of 57.5 inches.

Clause 11. A method of utilizing previously unused spaced within an internal cabin of an aircraft, the method comprising:
disposing a first seating system including three seats coupled together within a row within a tapered area of the internal cabin,
wherein the three seats include an inboard seat, a middle seat, and an outboard seat.

Clause 12. The method of Clause 11, wherein the tapered area is proximate to an aft end of the aircraft.

Clause 13. The method of Clauses 11 or 12, wherein the tapered area includes a last row of a passenger seating area.

Clause 14. The method of any of Clauses 11-13, further comprising disposing a second seating system in front of the first seating system, wherein the first seating system extends a distance further into an aisle than the second seating system.

Clause 15. The method of Clause 14, wherein the distance is between 0.1-2 inches.

Clause 16. The method of Clauses 14 or 15, wherein the first seating system has a first width that differs from a second width of the second seating system.

Clause 17. The method of any of Clauses 14-16, further comprising disposing a third seating system inboard from the first seating system, wherein the third seating system has a third width that differs from each of the first width and the second width.

Clause 18. An aircraft comprising:
an internal cabin having a tapered area;
a first seating system including three seats coupled together within a row within the tapered area, wherein the three seats include an inboard seat, a middle seat, and an outboard seat, and wherein the first seating system has a first width;
a second seating system in front of the first seating system, wherein the first seating system extends a distance further into an aisle than the second seating system, and wherein the second seating system has a second width that differs from the first width; and
a third seating system inboard from the first seating system, wherein the third seating system has a third width that differs from each of the first width and the second width.

Clause 19. The aircraft of Clause 18, wherein the distance is between 0.1-2 inches.

Clause 20. The aircraft of Clauses 18 or 19, wherein the first width is between 55-58 inches.

As described herein, examples of the present disclosure provide seating systems that are able to be disposed within an unused space of an internal cabin of an aircraft. Further, examples of the present disclosure allow for additional seats within an internal cabin of an aircraft.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An aircraft comprising:
an internal cabin having a tapered area; and
a first seating system including three seats coupled together within a row within the tapered area,
wherein the three seats include an inboard seat, a middle seat, and an outboard seat.

2. The aircraft of claim 1, wherein the tapered area is proximate to an aft end of the aircraft.

3. The aircraft of claim 1, wherein the tapered area includes a last row of a passenger seating area.

4. The aircraft of claim 1, further comprising a second seating system in front of the first seating system, wherein the first seating system extends a distance further into an aisle than the second seating system.

5. The aircraft of claim 4, wherein the distance is between 0.1-2 inches.

6. The aircraft of claim 4, wherein the first seating system has a first width that differs from a second width of the second seating system.

7. The aircraft of claim 4, further comprising a third seating system inboard from the first seating system, wherein the third seating system has a third width that differs from each of the first width and the second width.

8. The aircraft of claim 1, wherein the first seating system has a width of 56.6 inches.

9. The aircraft of claim 1, wherein the first seating system has a width of 55.6 inches.

10. The aircraft of claim 1, wherein the first seating system has a width of 57.5 inches.

11. A method of utilizing previously unused spaced within an internal cabin of an aircraft, the method comprising:
disposing a first seating system including three seats coupled together within a row within a tapered area of the internal cabin,
wherein the three seats include an inboard seat, a middle seat, and an outboard seat.

12. The method of claim 11, wherein the tapered area is proximate to an aft end of the aircraft.

13. The method of claim 11, wherein the tapered area includes a last row of a passenger seating area.

14. The method of claim 11, further comprising disposing a second seating system in front of the first seating system, wherein the first seating system extends a distance further into an aisle than the second seating system.

15. The method of claim 14, wherein the distance is between 0.1-2 inches.

16. The method of claim 14, wherein the first seating system has a first width that differs from a second width of the second seating system.

17. The method of claim 14, further comprising disposing a third seating system inboard from the first seating system, wherein the third seating system has a third width that differs from each of the first width and the second width.

18. An aircraft comprising:
an internal cabin having a tapered area;
a first seating system including three seats coupled together within a row within the tapered area, wherein the three seats include an inboard seat, a middle seat, and an outboard seat, and wherein the first seating system has a first width;
a second seating system in front of the first seating system, wherein the first seating system extends a distance further into an aisle than the second seating system, and wherein the second seating system has a second width that differs from the first width; and
a third seating system inboard from the first seating system, wherein the third seating system has a third width that differs from each of the first width and the second width.

19. The aircraft of claim 18, wherein the distance is between 0.1-2 inches.

20. The aircraft of claim 18, wherein the first width is between 55-58 inches.
